(19) United States
(12) Patent Application Publication
(10) Pub. No.: US 2016/0249666 A1
(43) Pub. Date: Sep. 1, 2016

(54) METHOD OF PROCESSING EGGSHELL RESIDUES

(71) Applicant: AGROPLAS AS, Oslo (NO)

(72) Inventors: Ståle Amundsen, Bø (NO); Bjørn Utgård, Oslo (NO); Henri-Pierre Suso, Oslo (NO)

(73) Assignee: Biovotec AS, Oslo (NO)

(21) Appl. No.: 15/030,055

(22) PCT Filed: Oct. 22, 2013
(86) PCT No.: PCT/EP2013/072049

§ 371 Date: Apr. 16, 2016

(51) Int. Cl. A23B 4/03; B02C 19/06; B03B 9/06; B02C 23/08

(52) U.S. Cl. CPC A23L 1/32; A23L 1/304; A23L 1/305; B03B 9/061; B02C 23/08; B02C 19/063; A23V 2002/00

(57) ABSTRACT

The invention concerns a method of processing eggshell residues, which emanate from an egg breaking unit (1) and comprise eggshell portions as well as membrane portions. The method comprises feeding of the eggshell residues into a cyclone (5), which is driven by a process gas having a temperature of less than 85° C. In said cyclone (5) vortex processing of the eggshell residues leads to peeling of said membrane portions off of said eggshell portions, such that said eggshell portions become separated from said membrane portions. A mix mainly of process gas, vapour and droplets is released through a top outlet (6) of said cyclone (5), whereas a mixture mainly of separated eggshell portions and membrane portions is released through a bottom outlet (7) of said cyclone (5). Finally in a sorting device (8) sorting of said released mixture is performed into an eggshell portion part and a membrane portion part.

### TECHNICAL FIELD

The present invention concerns a method of processing eggshell residues, which emanate from an egg breaking unit and comprise eggshell portions as well as membrane portions.

### PRIOR ART

Eggshell residues emanating from an egg breaking unit form a valuable source of both minerals (mostly calcium) from the eggshell portions and proteins from the membrane portions. However, in order to make use of that source first the eggshell portions and the membrane portions have to be strictly separated, which has to be done in a careful way so that the protein content is not deteriorated.

From U.S. Pat. No. 6,649,203 B1 an eggshell processing method is known, comprising separation of outer eggshell portions and membrane portions. According to the known method fresh eggshell residues are first centrifuged to remove adhering liquid egg. Then the eggshell residues are washed in water to remove residual liquid egg. The next step of the known method comprises once again centrifuging and then, at a temperature of just slightly less than 90° C., drying to a low moisture content. Next comes vibratory screening aiming at removing loose membrane portions. The remainder is then milled coarsely and treated pneumatically to remove some additional freed membrane portions, and then milled finely before packaging.

The fact that the known method comprises a washing step, makes it require not only use of plenty of water but also of extra centrifuging and drying steps. Hence, the known method is neither particularly economical nor environmentally friendly, and above that the rather high drying temperature of just slightly less than 90° C. tends to deteriorate quality of the proteins of the membrane portions.

### OBJECT OF THE INVENTION

In the light of the above, it is an object of the present invention to mitigate the drawbacks of the prior art solution and to provide a method of processing eggshell residues which is economically and environmentally more feasible and further less harmful to the proteins involved.

### BRIEF SUMMARY OF THE INVENTION

According to the invention this is achieved by means of a method of processing eggshell residues, which emanate from an egg breaking unit and comprise eggshell portions as well as membrane portions, the method being characterised by the following steps:

feeding eggshell residues, having a particle size of 0.5 mm to 40 mm and a wet basis moisture content of 3% to 40%, from said egg breaking unit into a cyclone, which, at a speed exceeding 60 m/s, and preferably between 70 m/s and 340 m/s, is driven by a process gas, which has a temperature of less than 85° C., and preferably of less than 60° C.,

in said cyclone, vortex processing of the eggshell residues to reduce particle size and to peel said membrane portions off of said eggshell portions, such that said eggshell portions become separated from said membrane portions,

through a top outlet of said cyclone, releasing mainly a mix of process gas, vapour and droplets,

through a bottom outlet of said cyclone, releasing mainly a mixture of separated eggshell portions and membrane portions, and,

in a sorting device, sorting of said released mixture into an eggshell portion part and a membrane portion part.

The method according to the invention does not comprise any washing step. This is environmentally beneficial and saves equipment and operation costs. Further, it does not comprise any centrifuging step to throw washing liquid off, which is advantageous for the same reasons as the lack of a washing step. And finally, the method according to the invention does not comprise an energy consuming drying step operating at a temperature just slightly below 90° C. and therefore tending to deteriorate protein quality.

Preferably the method according to the invention comprises the further step of controlling time between feeding eggshell residues into and releasing said mixture out of said cyclone by adjusting an eggshell residue feed rate in relation to a total process gas feed rate, wherein said time may be confined into an interval of 0.5 s to 20 s, and preferably of 1 s to 5 s. In other words, two factors that can be easily controlled, that is the eggshell residue feed rate and the process gas feed rate, are suitably used to arrive at an optimum result, while energy consumption is kept low and process time reduced to an extremely short time.

In order to take care of as much liquid egg as possible the method according to the invention preferably comprises the further step of centrifuging the eggshell residues prior to feeding them into said cyclone. This leads to the additional advantage that the following cyclone step can be performed under dryer and therefore better conditions.

According to a preferred embodiment the method according to the invention comprises the step of continuous feeding of eggshell residues into the cyclone. Continuous feeding leads to maximum use of the equipment at hand and helps achieving stable operating conditions for the cyclone used.

During the step of sorting blowing of process gas to pneumatically expel said membrane portion part off of sorting screens and out of the sorting device has turned out to be most efficient. However, that does not exclude the possibility to use an all different sorting device, such as an aspirator.

Preferably, according to the invention both said eggshell portion part and said membrane portion part are dried after having been sorted. Further, said parts are optionally milled as well after having been sorted. In any case the goal of these measures is to arrive at end products which are of an even and high quality and suitable for packaging and transport.

### BRIEF DESCRIPTION OF THE DRAWINGS

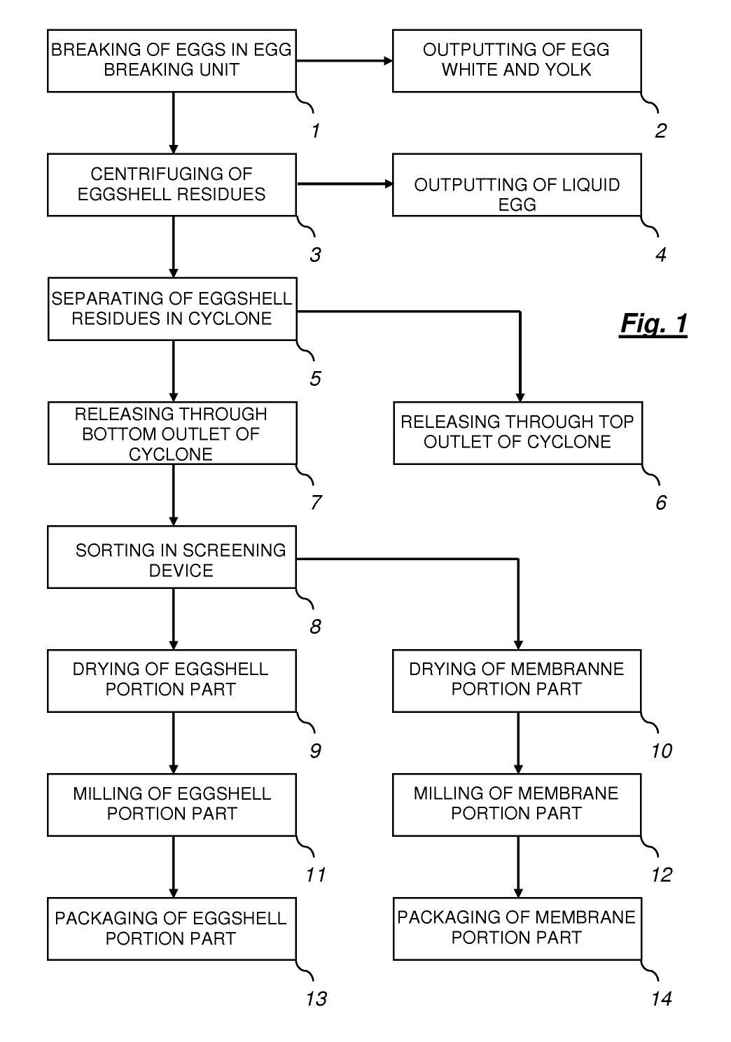

On the drawings FIG. 1 shows a flow chart which illustrates steps of a method according to a preferred embodiment of the invention.

### DETAILED DESCRIPTION OF A PREFERRED EMBODIMENT

Hundreds of thousands of tons of eggshell residues are produced at egg breaking facilities worldwide. While eggshells contain substances with high potential economic value, eggshell residues are often disposed as waste. Meanwhile, the demand for pure and clean, natural mineral and protein ingredients is growing in a number of industries, including cosmetics, cosmeceuticals, nutraceuticals, pharmaceuticals, functional food, animal feed, etc. Against that background an object of the present invention is to provide a method of processing eggshell residues in order to produce eggshell derived ingredients.

Eggshell residues comprise protein rich membrane particles and mineral rich shell particles which are entangled and must be separated into two separate material flows to allow further processing and commercial application. Besides problems caused by particle entanglement, another problem met in this context is that proteins are sensitive to temperature and must be kept at temperatures below 55° C. to avoid product degradation.

This has made the inventors look for a method more lenient than known solutions and made them finally arrive at a method comprising use of a low temperature, high speed cyclone. By this is meant a cyclone driven by a process gas holding a temperature of less than 85° C. and a speed exceeding 60 m/s.

It turns out that such a cyclone is able to peel membrane particles off eggshell particles within a few seconds or even fractions of a second, thus guaranteed keeping temperature of the particles involved sufficiently low to avoid degradation. Within the cyclone the separation process makes use of the difference in brittleness and elasticity between the eggshell particles (predominantly containing minerals) and the membrane particles (predominantly containing proteins) to separate entangled (composite) particles into pure mineral and protein particles.

In the following the above is illustrated by means of a detailed description of a preferred embodiment of the method according to the invention with reference being had at the enclosed drawings.

In the drawings box 1 illustrates an egg breaking step in an egg breaking unit. This unit outputs egg white and yolk (c.f. box 2) and eggshell residues. These comprise eggshell and membrane portions as well as some liquid egg and are fed into a centrifuge (c.f. box 3).

In the centrifuge most of the liquid egg is thrown off the eggshell and membrane portions and led to an output (c.f. box 4), while the remaining eggshell residue particles, having a size of 0.5 mm to 30 mm and a wet basis moisture content of 3% to 40%, are fed into a high speed cyclone (c.f. box 5).

The cyclone is driven by a process gas, which holds a temperature of preferably less than 60° C. and a speed preferably within an interval of 70 m/s to 340 m/s. Within the cyclone the process gas causes a vortex flow, that entangles the eggshell residues and makes them collide with each other and cyclone walls. This makes the brittle eggshell portions break into smaller pieces while the elastic membrane portions are peeled off, all within a stay time inside the cyclone of preferably between 1 s and 5 s.

Through a top outlet of the cyclone a mix of mainly gas, vapour and droplets is released (c.f. box 6), and through a bottom outlet of the cyclone a mixture mainly containing separated eggshell portions and membrane portions are released (c.f. box 7).

Said mixture of eggshell portions and membrane portions is then fed into a sorting device (c.f. box 8), in which sorting into an eggshell portion part and a membrane portion part is performed, for instance by means of vibrating screens and/or an aspirator, i.e. means well known to a person skilled in the art.

From the sorting device the eggshell portion part is optionally fed into a dryer (c.f. box 9), in which the moisture content is lowered to an adequate level, e.g. for packaging and storing. The same goes for the membrane portion part, which is fed into a dryer (c.f. box 10), also in order to arrive at an appropriate moisture content level for packaging, transport and storing without degradation.

From the dryer the eggshell portion part is then led into an optional mill (c.f. box 11), in which particle size is reduced to a desired even level, before the particles reach a final packaging stage (c.f. box 13).

The membrane portion part is optionally led from the dryer into a mill (c.f. box 12), in which it is ground before packaging (c.f. box 14).

It is obvious to a person skilled in the art that there are several ways of altering the method described above within the frame set up by the appendent claims. However, no matter how the method is altered, it is important that the protein content of the membrane portions always is treated carefully and not exposed to temperatures causing degradation.

1-10. (canceled)

11. A method of processing eggshell residues, the method comprising:
feeding eggshell residues from an egg breaking unit into a cyclone, the eggshell residues comprising eggshell portions and membrane portions, the eggshell residues having particle sizes substantially in the range of 0.5 mm to 40 mm, the eggshell residues having a wet basis moisture content substantially in a range of 3% to 40%, wherein the cyclone operates at a speed exceeding 60 m/s and is driven by a process gas, wherein the process gas has a temperature of 85° C. or less;
processing the eggshell residues in the cyclone such that particle size is reduced and such that said eggshell portions become separated from said membrane portions of the eggshell residue;
releasing a mix of process gas, vapour, and droplets through a top outlet of said cyclone;
releasing a mixture of separated eggshell portions and membrane portions through a bottom outlet of said cyclone; and
sorting said released mixture of separated eggshell portions and membrane portions into an eggshell portion part and a membrane portion part using a sorting device.

12. The method according to claim 11, further comprising:
controlling an amount of time between feeding the eggshell residues into the cyclone and releasing said mixture of separated eggshell portions and membrane portions out of said cyclone by adjusting an eggshell residue feed rate in relation to a total process gas feed rate.

13. The method according to claim 12, wherein said amount of time is within an interval of 0.5 seconds to 20 seconds.

14. The method according to claim 11, further comprising:
centrifuging the eggshell residues prior to feeding them into said cyclone.

15. The method according to claim 11, the eggshell residues are fed into the cyclone substantially continuously.

16. The method according to claim 11, wherein sorting said released mixture of separated eggshell portions and membrane portions into the eggshell portion part and the membrane portion part using the sorting device comprises blowing air in order to pneumatically expel said membrane portion part off of sorting screens and out of the sorting device.

17. The method according to claim 11, further comprising drying said eggshell portion part.

18. The method according to claim 11, further comprising drying said membrane portion part.

19. The method according to claim 11, further comprising milling said eggshell portion part.

20. The method according to claim 11, further comprising milling said membrane portion part.

21. The method according to claim 11, the cyclone operates at a speed between 70 m/s and 340 m/s.

22. The method according to claim 11, wherein the process gas has a temperature of 60° C. or less.

23. An eggshell residue processing device comprising:
a cyclone configured to:
receive a feed of eggshell residues from an eggshell breaking unit, the eggshell residues comprising eggshell portions and membrane portions, the eggshell residues having particle sizes substantially in the range of 0.5 mm to 40 mm, the eggshell residues having a wet basis moisture content substantially in a range of 3% to 40%, wherein the cyclone is configured to operate at a speed exceeding 60 m/s and is driven by a process gas, wherein the process gas has a temperature of 85° C. or less, and
process the eggshell residues such that said eggshell portions become separated from said membrane portions of the eggshell residue, wherein the cyclone comprises a top outlet configured to release a mix of process gas, vapour, and droplets, and the cyclone comprises a bottom outlet configured to release a mixture of separated eggshell portions and membrane portions; and
a sorting device configured to sort said released mixture of separated eggshell portions and membrane portions into an eggshell portion part and a membrane portion part.

24. The device according to claim 23, wherein an amount of time between feeding the eggshell residues into the cyclone and releasing said mixture of separated eggshell portions and membrane portions out of said cyclone is controlled by adjusting an eggshell residue feed rate in relation to a total process gas feed rate.

25. The device according to claim 24, wherein said amount of time is within an interval of 0.5 seconds to 20 seconds.

26. The device according to claim 23, further comprising:
a centrifuge configured to centrifuge the eggshell residues prior to feeding them into said cyclone.

27. The device according to claim 23, wherein the cyclone is configured to receive the eggshell residues substantially continuously.

28. The device according to claim 23, wherein sorting device is configured to sort said released mixture of separated eggshell portions and membrane portions into the eggshell portion part and the membrane portion part by being configured to blow air in order to pneumatically expel said membrane portion part off of sorting screens and out of the sorting device.
